(19) United States
(12) Patent Application Publication
(10) Pub. No.: US 2011/0316887 A1
(43) Pub. Date: Dec. 29, 2011

(54) ELECTRONIC DEVICE WITH A TOUCH SCREEN AND TOUCH OPERATION CONTROL METHOD UTILIZED THEREBY

(75) Inventor: CHAO-TSUNG FAN, Tu-Cheng (TW)

(73) Assignee: HON HAI PRECISION INDUSTRY CO., LTD., Tu-Cheng (TW)

(21) Appl. No.: 13/071,419

(22) Filed: Mar. 24, 2011

(30) Foreign Application Priority Data
Jun. 28, 2010 (TW) 99121062

(51) Int. Cl. G06T 3/40; G06F 3/041

(52) U.S. Cl. 345/661

(57) ABSTRACT

In a touch operation control method, touch operations on a touch screen of an electronic device are controlled. The touch operation is detected when the touch screen is touched, and the touch operation is analyzed to determine whether the touch operation is a tap touch or a hold touch. If the touch operation is the hold touch, a target area is determined from a user interface displayed on the touch screen, and operating options of the user interface that are within the target area are enlarged by displaying the target area full screen on the touch screen.

### BACKGROUND

1. Technical Field

Embodiments of the present disclosure relate generally to electronic device management, and more particularly, to a touch operation control system and method of an electronic device.

2. Description of Related Art

Touch screens may be used to receive touch input from a user on electronic devices, such as, mobile phones, personal digital assistants (PDA), and mobile internet devices (MID). The touch input may be used to execute a corresponding function of the electronic devices. However, most of the electronic devices use a small touch screen to maintain portability of the device. Because of their small size, touch screens may be difficult to operate accurately.

### BRIEF DESCRIPTION OF THE DRAWINGS

FIG. 1 is a block diagram of one embodiment of an electronic device including a touch control system.

FIG. 2 is a flowchart of one embodiment of a touch operation control method of the electronic device of FIG. 1.

FIG. 3 is a block diagram of one embodiment of user interfaces displayed on a touch screen of the electronic device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

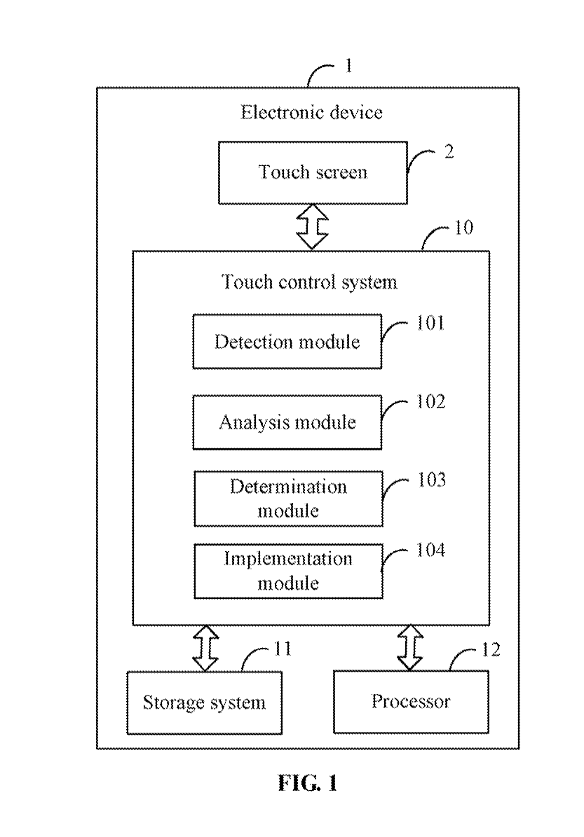

FIG. 1 is a block diagram of one embodiment of an electronic device 1 including a touch control system 10. In the embodiment, the electronic device 1 further includes a touch screen 2, a storage system 11, and a processor 12. The electronic device 1 may be a mobile phone, a personal digital assistant (PDA), or a mobile internet device (MID). It should be apparent that FIG. 1 is only one example of the electronic device 1 and that it can be comprised of more or less components in other embodiments, or a different configuration of the various components.

The storage system 11 stores one or more programs, such as programs of an operating system, and other applications of the electronic device 1. In one embodiment, the storage system 11 may be random access memory (RAM) for temporary storage of information, and/or a read only memory (ROM) for permanent storage of information. In other embodiments, the storage system 11 may also be an external storage device, such as a hard disk, a storage card, or a data storage medium. The processor 12 executes computerized operations of the electronic device 1 and other applications to provide functions of the electronic device 1.

The touch control system 10 may include a plurality of functional modules comprising one or more computerized instructions that are stored in the storage system 11 or a computer-readable medium of the electronic device 1, and executed by the processor 12 to perform operations of the electronic device 1. In the embodiment, the touch control system 10 includes a detection module 101, an analysis module 102, a determination module 103, and an implementation module 104. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

The detection module 101 is operable to initialize the touch screen 2, which may be capacitive or resistive, when the electronic device 1 is powered on, and detect touch operations on the touch screen 2. The touch operation may be done with a finger or tool, such as a stylus.

The analysis module 102 is operable to determine a type of the touch operation. In the embodiment, the touch operation may be a tap touch, or a hold touch. Touches lasting for less than a predetermined time (e.g., less than a ½ second) are tap touches, and touches lasting for more than the predetermined time are hold touches. In this embodiment, tap touches are used to selection a menu item presented on the touch screen 2, and hold touches are used to control display parameters of items presented on the touch screen 2, details of which are described below.

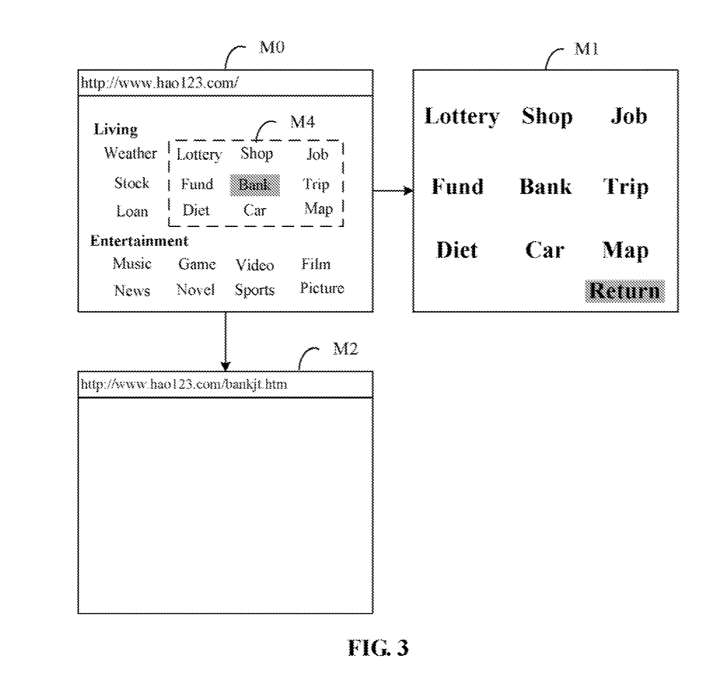

The determination module 103 is operable to determine a target area from a user interface displayed on the touch screen 2 when the touch operation is a hold touch. In one embodiment, the target area may be a rectangular region on the user interface. The rectangular region has a geometric center that is a touch position (e.g., “Bank” of a rectangular region M4 in FIG. 3) of the touch operation. Length of the rectangular region M4 is determined as a first preset distance, such as three centimeters, and width of the rectangular region M4 is determined as a second preset distance, such as two centimeters. More details of the target area are provided in FIG. 3 as described below.

FIG. 3 is a block diagram of one embodiment of user interfaces M0, M1, M2 displayed on the touch screen 2 of the electronic device 1. In the user interface M0, assuming that the touch position of the touch operation is located on an operating option “Bank”, a rectangular region M4 on the user interface M0 may be determined to be the target area. The first preset distance and the second preset distance may be determined according to the size of a display area of the touch screen 2. For example, if the display area of the touch screen 2, such as the user interface M0 in FIG. 3 is a rectangle of 6 cm×4 cm, then the first preset distance may be determined as 3 cm, and the second preset distance may be determined as 2 cm. It should be understood that the operating options may be icons, texts, or other UI elements, that upon selection thereof, may be used to execute a corresponding function of the electronic device 1.

The implementation module 104 is operable to enlarge operating options within the target area by displaying the target area on the touch screen 2 full screen. In respect to FIG. 3, the target area M4 may be displayed full screen (e.g., a user interface M1 of FIG. 3). The user may, for example, tap touch one of the enlarged operating options to perform a corresponding function of the electronic device 1, or tap touch a button “Return” on the user interface M1 to return to the user interface M0. When the target area is displayed in full screen on the touch screen 2, the user may accurately select an operating option according to determined requirements, so as to overcome wrong touch inputs due to the limiting size of touch screen 2. When a selection of the target area is made by the user, the target area may return to a normal size.

Upon the condition that the touch operation is a tap touch, the implementation module 104 is further operable to control the electronic device 1 to execute a function corresponding to the tap touch. For example, if a touch position of the tap touch is located on an operating option “Bank” of the user interface M0 in FIG. 3, the implementation module may control the electronic device 1 to open a webpage linked to the operating option “Bank”.

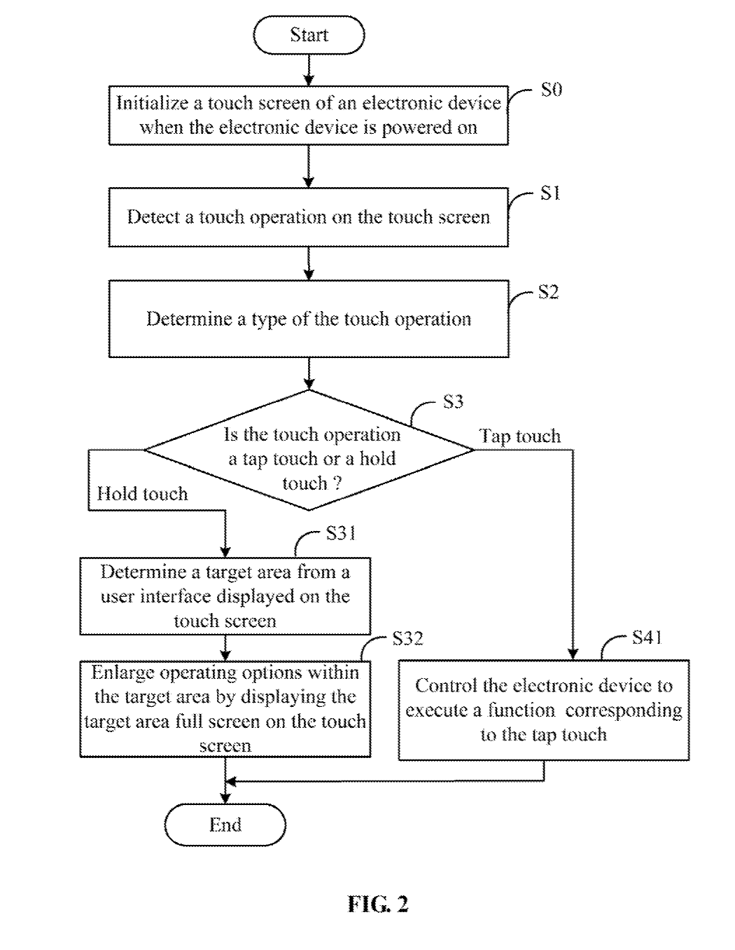

FIG. 2 is a flowchart of one embodiment of a touch operation control method of the electronic device 1 of FIG. 1. Depending on the embodiment, additional blocks may be added, others removed, and the ordering of the blocks may be changed.

In block S0, the detection module 101 initializes the touch screen 2 when the electronic device 1 is powered on.

In block S1, the detection module 101 detects a touch operation on the touch screen 2 when the touch screen 2 is touched.

In block S2, the analysis module 102 determines a type of the touch operation (e.g., a tap touch or a hold touch).

In block S3, the analysis module 102 determines whether the touch operation is the tap touch or the hold touch. If the touch operation is the tap touch, block S41 is implemented. Otherwise, if the touch operation is the hold touch, then block S31 is implemented.

In block S31, the determination module 103 determines a target area from a user interface displayed on the touch screen 2. In one embodiment, the target area may be a rectangular region as previously described.

In block S32, the implementation module 104 enlarges operating options within the target area by displaying the target area full screen on the touch screen 2, and ends the procedure. When the target area is full screen displayed on the touch screen 2, the user may accurately select an operating option according to determined requirements, so as to overcome wrong touch inputs due to the touch screen 2 may be very small.

In block S41, the implementation module 104 controls the electronic device 1 to execute a function corresponding to the tap touch in response to the touch operation being the tap touch as described above.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A touch operation control method of an electronic device comprising a touch screen, the method comprising:
detecting a touch operation on the touch screen;
determining whether the touch operation is a tap touch or a hold touch;
determining a target area from a user interface displayed on the touch screen, and enlarging operating options of the user interface that are within the target area by displaying the target area full screen on the touch screen, if the touch operation is the hold touch; or
controlling the electronic device to execute a function corresponding to the tap touch if the touch operation is the tap touch.

2. The method according to claim 1, wherein the target area is a rectangular region on the user interface having a geometric center that is a touch position of the touch operation, where length of the rectangular region is determined as a first preset distance, and width of the rectangular region is determined as a second preset distance.

3. The method according to claim 1, wherein the operating options are icons or texts of the user interface.

4. The method according to claim 1, wherein the tap touch is a touch operation on the touch screen that lasts for less than a predetermined time.

5. The method according to claim 3, wherein the hold touch is a touch operation on the touch screen that lasts for more than the predetermined time.

6. An electronic device, comprising:
a touch screen;
at least one processor;
a storage system; and
one or more programs stored in the storage system and being executable by the at least one processor, the one or more programs comprising:
a detection module operable to detect a touch operation on the touch screen;
an analysis module operable to determine whether the touch operation is a tap touch or a hold touch;
a determination module operable to determine a target area from a user interface displayed on the touch screen if the touch operation is the hold touch; and
an implementation module operable to enlarge operating options of the user interface that are within the target area by displaying the target area full screen on the touch screen, or control the electronic device to execute a function corresponding to the tap touch in response to the touch operation being the tap touch.

7. The electronic device according to claim 6, wherein the target area is a rectangular region on the user interface having a geometric center that is a touch position of the touch operation, where length of the rectangular region is determined as a first preset distance, and width of the rectangular region is determined as a second preset distance.

8. The electronic device according to claim 6, wherein the operating options are icons or texts of the user interface.

9. The electronic device according to claim 6, wherein the tap touch is a touch operation on the touch screen that lasts for less than a predetermined time.

10. The electronic device according to claim 9, wherein the hold touch is a touch operation on the touch screen that lasts for more than the predetermined time.

11. A non-transitory storage medium storing a set of instructions, the set of instructions capable of being executed by a processor of an electronic device, to perform a touch operation control method, the method comprising:
detecting a touch operation on a touch screen of the electronic device;
determining whether the touch operation is a tap touch or a hold touch;
determining a target area from a user interface displayed on the touch screen, and enlarging operating options of the user interface that are within the target area by displaying the target area full screen on the touch screen, if the touch operation is the hold touch; or
controlling the electronic device to execute a function corresponding to the tap touch if the touch operation is the tap touch.

12. The storage medium as claimed in claim 11, wherein the target area is a rectangular region on the user interface having a geometric center that is a touch position of the touch operation, where length of the rectangular region is determined as a first preset distance, and width of the rectangular region is determined as a second preset distance.

13. The storage medium as claimed in claim 11, wherein the operating options are icons or texts of the user interface.

14. The storage medium as claimed in claim 11, wherein the tap touch is a touch operation on the touch screen that lasts for less than a predetermined time.

15. The storage medium as claimed in claim 14, wherein the hold touch is a touch operation on the touch screen that lasts for more than the predetermined time.
